(19) United States
(12) Patent Application Publication
(10) Pub. No.: US 2002/0170339 A1
(43) Pub. Date: Nov. 21, 2002

(54) Ultrasound phantom simulating hard and soft tissue of a vertebrate and methods of production and use thereof

(75) Inventors: Garri Passi, Ashdod (IL); Asaf Ben-Arye, Zichron Yaakov (IL); Shmuel Douvdevani, Nes Ziona (IL); Alon Eitan, Tel Aviv (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: MEDSON LTD.

(21) Appl. No.: 09/855,583

(22) Filed: May 16, 2001

(51) Int. Cl. G01N 37/00; G01N 29/06

(52) U.S. Cl. 73/1.86; 73/1.82; 73/866.4

(57) ABSTRACT

An ultrasound phantom simulating hard and soft tissue of a vertebrate and methods of production and use of same. The ultrasound phantom includes a hard tissue derived from a second vertebrate organism and a material covering at least a portion thereof. The material has ultrasonic properties similar to those of soft tissue. Also disclosed is a method of producing an ultrasound phantom simulating hard and soft tissue of a first vertebrate organism. The method includes the steps of removing a hard tissue from a second vertebrate organism and covering at least a portion thereof with a material. Also disclosed is a method of testing an ultrasonic diagnostic system. The method includes the steps of transmitting a train of ultrasonic energy towards a phantom of the present invention, receiving a portion of the train of ultrasonic energy and analyzing the received portion.

### FIELD AND BACKGROUND OF THE INVENTION

The present invention relates, in general, to the field of ultrasound phantoms for use with ultrasonic medical diagnostic systems, and in particular, the present invention is of an ultrasound phantom simulating hard and soft tissue of a vertebrate. The present invention is further of methods for production and use of disclosed ultrasound phantoms.

Recent years have introduced significant progress in the development and use of ultrasonic diagnostic systems for the evaluation of human hard tissue, such as bone and cartilage tissue. For example, a novel ultrasonic apparatus and method for the evaluation of bone tissue has been recently disclosed in PCT International Publication Number WO 00/24307 to Medson Ltd. The progress in ultrasonic techniques for evaluation of hard tissue has brought forth a need for an ultrasound phantom which simulates hard tissue of a vertebrate and its surrounding soft tissue environment.

Ultrasound phantoms, e.g. materials which are structured so as to mimic the ultrasonic properties of a human or animal organ, are commonly used for testing or calibrating ultrasonic medical diagnostic systems, or for training new users of such systems, as well as for other useful purposes. However, very few ultrasound phantoms mimicking both hard and soft tissue are currently known in the art. U.S. Pat. No. 5,625,137 issued to Madsen et al. discloses a water based liquid and solid tissue mimicking material for ultrasound phantoms. U.S. Pat. No. 6,190,915 also issued to Madsen et al. discloses an ultrasound phantom which includes a container containing a phantom body, which phantom body comprises a water based tissue mimicking material. However, both these patents can not sufficiently simulate hard and soft tissue of a vertebrate since they rely solely on artificial, non-organic matter.

There is thus a recognized need for, and it would be highly advantageous to provide an ultrasound phantom simulating hard and soft tissue of a vertebrate and methods of production and use thereof, devoid of the above limitations.

### SUMMARY OF THE INVENTION

According to one aspect of the present invention there is provided an ultrasound phantom simulating hard and soft tissue of a first vertebrate organism. The phantom includes (a) a hard tissue derived from a second vertebrate organism and (b) a material covering at least a portion of the hard tissue derived from a second vertebrate organism, the material having ultrasonic properties similar to those of soft tissue.

According to further features in preferred embodiments of the invention described below, the hard tissue derived from a second vertebrate organism exhibits ultrasonic properties similar to the hard tissue in situ in the second vertebrate organism.

According to still further features in the described preferred embodiments of the invention described below, the hard tissue derived from a second vertebrate organism exhibits ultrasonic properties similar to the hard tissue of the first vertebrate organism in situ.

According to still further features in the described preferred embodiments the first vertebrate organism and the second vertebrate organism are each independently selected from the group consisting of a rodent, a canine species, a feline species, an ovine species, a bovine species, a caprine species, a porcine species, an equine species, an avian species, an ichthyic species, a primate species and a human being.

According to still further features in the described preferred embodiments the hard tissue derived from a second vertebrate organism includes at least one item selected from the group consisting of bone tissue, cartilage tissue and teeth.

According to still further features in the described preferred embodiments the hard tissue derived from a second vertebrate organism exhibits a clinical pathology.

According to still further features in the described preferred embodiments the clinical pathology is selected from the group consisting of a fracture, abnormal growth, metabolic disease, osteoporosis, osteomyelitis, osteoarthritis, osteonecrosis and presence of at least one tumor.

According to still further features in the described preferred embodiments the hard tissue derived from a second vertebrate organism further includes at least one medical accessory.

According to still further features in the described preferred embodiments the medical accessory is selected from the group consisting of a nail, a screw, a pin, a staple and an anchor.

According to still further features in the described preferred embodiments the material covering at least a portion of the hard tissue derived from a second vertebrate organism includes at least one item selected from the group consisting of a liquid, a gel, a polymeric and a granular material.

According to still further features in the described preferred embodiments the phantom further includes (c) a container. The container is capable of containing the hard tissue derived from a second vertebrate organism and the material covering at least a portion of the hard tissue.

According to still further features in the described preferred embodiments the container is selected from the group consisting of a rigid container and a flexible container.

According to still further features in the described preferred embodiments the container includes at least two pieces, such that the container may be opened and closed.

According to still further features in the described preferred embodiments the phantom further includes (d) a means for fixing a position of the hard tissue derived from a second vertebrate organism within the container.

According to still further features in the described preferred embodiments the means for fixing a position employs a foam.

According to another aspect of the present invention there is provided a method of producing an ultrasound phantom simulating hard and soft tissue of a first vertebrate organism. The method includes the steps of (a) removing a hard tissue from a second vertebrate organism and (b) covering at least a portion of the hard tissue from the second vertebrate organism with a material having ultrasonic properties similar to those of a soft tissue.

According to still further features in the described preferred embodiments the method of producing includes the additional step of (c) containing within a container, the hard tissue derived from a second vertebrate organism and the material covering at least a portion of the hard tissue.

According to still further features in the described preferred embodiments the method of producing includes the additional step of (d) fixing a position of the hard tissue derived from a second vertebrate organism within the container.

According to yet another aspect of the present invention there is provided a method of testing an ultrasonic diagnostic system. The method includes the steps of: (a) transmitting a train of ultrasonic energy towards a phantom; (b) receiving a portion of the train of ultrasonic energy; and (c) analyzing the portion of the train of ultrasonic energy, wherein the phantom includes components as set forth hereinabove.

According to still further features in the described preferred embodiments the method of testing includes the additional step of (d) containing, within a container, the phantom.

According to still further features in the described preferred embodiments the method of testing includes the additional step of (e) fixing a position of the hard tissue derived from a second vertebrate organism within the container.

The present invention successfully addresses the shortcomings of the presently known configurations by providing an ultrasound phantom simulating hard and soft tissue of a vertebrate and methods of production and use thereof.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic, sectional illustration of an ultrasound phantom according to the teachings of the present invention; and

FIG. 2 is a schematic illustration of an ultrasonic diagnostic system featuring an ultrasound phantom according to the present invention.

### DETAILED DESCRIPTION OF THE INVENTION

The present invention is of an ultrasound phantom which can be used to simulate hard and soft tissue of a vertebrate. Specifically, the present invention can be used to generate images of a variety of clinical pathological conditions associated with bones, cartilage and teeth. The present invention is further of methods for production and use of disclosed ultrasound phantoms

The principles and operation of an ultrasound phantom according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention is embodied by an ultrasound phantom 10 simulating hard and soft tissue of a first vertebrate organism. The phantom includes a hard tissue 20 derived from a second vertebrate organism and a material 16 covering at least a portion of hard tissue 20. Material 16 possesses ultrasonic properties similar to those of soft tissue.

Preferably hard tissue 20 exhibits ultrasonic properties similar to the hard tissue in situ in the second vertebrate organism. Alternately or additionally, hard tissue 20 exhibits ultrasonic properties similar to the hard tissue of the first vertebrate organism in situ. In order to achieve this similarity of ultrasonic properties, it is desirable that hard tissue 20 is a fresh tissue (e.g. tissue removed from a recently slaughtered animal), although the use of fixed and partially decomposed tissues is within the scope of the claimed invention.

Hard tissue 20 may include, for example, bone tissue, cartilage tissue, teeth or combinations including same. Preferably, hard tissue 20 exhibits a clinical pathology, although the use of healthy tissues is within the scope of the claimed invention. Clinical pathologies include, but are not limited to, a fracture, abnormal growth, metabolic disease, osteoporosis, osteomyelitis, osteoarthritis, osteonecrosis and presence of at least one tumor. Alternately or additionally, hard tissue 20 further includes at least one medical accessory. A medical accessory may be, for example, a nail, a screw, a pin, a staple or an anchor or any other implement or device employed during a surgical procedure. Medical accessories may be attached to, adhered to or implanted within hard tissue 20.

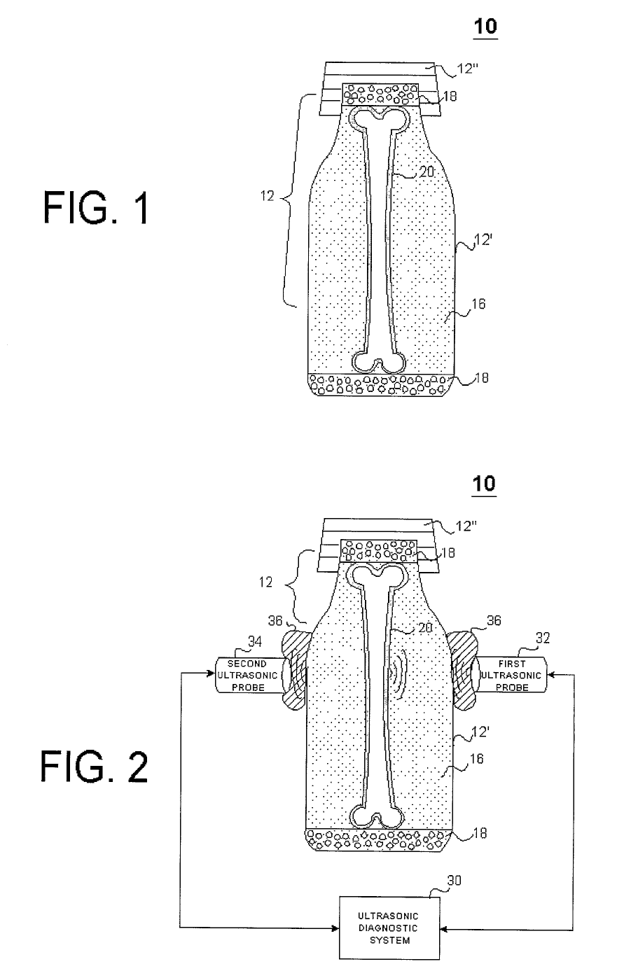

Hard tissue 20 is preferably similar or even identical in ultrasonic properties (e.g. attenuation, speed of sound, density) and in structure (e.g. shape, size) to the hard tissue which it is aimed to simulate. FIG. 1 illustrates an example of a whole, non-fractured animal thighbone serving as hard tissue 20 in an ultrasound phantom 10 which simulates a human upper arm.

As mentioned hereinabove, material 16 has ultrasonic properties similar to those of soft tissue. Material 16 may be, for example, a liquid, gel, granular, polymeric or any other material, either organic or non-organic, which is known in the art to possess ultrasonic properties (e.g. attenuation, speed of sound, density) similar to soft tissue, and preferably similar to soft tissue which it is aimed to mimic. For example, it is known in the art that filtered water possesses ultrasonic properties similar to those of the soft tissue which surrounds human bones (e.g. blood vessels, muscles, skin), and therefore such water can be used as material 16. In addition, material 16 may further contain a preservative substance for preserving and reducing decay of hard tissue 20. Preferably material 16 covers hard tissue 20 or a portion thereof, to the extent that no air remains between the covered portion of hard tissue 20 and material 16. This configuration eliminates the high ultrasonic attenuation typically caused by air.

Phantom 10 can be structured, for example, to mimic a relatively regular-structure vertebrate organ, such as a human thigh, upper arm, or portion thereof. Alternatively, phantom 10 can be structured to mimic a vertebrate organ of more intricate or irregular structure, such as a human wrist, pelvis, or portion thereof. In FIG. 1, for example, phantom 10 simulates a human upper arm, i.e., a humerus and its surrounding soft tissue.

The first vertebrate organism and the second vertebrate organism may be similar or different. Each may be, for example, a rodent, a canine, a feline, an ovine, a bovine, a caprine, a porcine, an equine, an avian, an ichthyic (bony fish), a primate or a human being. Because the present invention is typically employed in medicine, the first organism is typically a human being. However, the invention as disclosed, might be employed with equal utility to the practice of veterinary medicine, and such use is within the scope of the present invention.

According to alternate preferred embodiments phantom 10 further includes a container 12. Container 12 is capable of containing hard tissue 20 and material 16. Conceivably, container 12 may be any type of vessel made of solid material. Container 12 is preferably similar in structure (e.g. shape, size) to the organ which phantom 10 mimics. In FIG. 1, for example, container 12 is generally cylindrical in shape since, as mentioned hereinabove, phantom 10 is aimed to mimic a human upper arm.

Preferably, walls of container 12 are sonolucent or cause low ultrasonic attenuation. For example, a low-density polyethylene container with walls of approximately 0.8 mm thickness is suitable for use as container 12. Container 12 may be, for example, a rigid container or a flexible container. As such, container 12 may be embodied, for example, by a jar, a bottle, a cup, a membrane, a bag or a sheet of flexible plastic. Container 12 can be completely sealed or partly open (such as an open-top container). In order to facilitate insertion of hard tissue 20 and material 16, container 12 may include at least two pieces, such that the container may be opened and closed. These pieces might be, for example, a main body and a cover. Alternately or additionally, the pieces may be two halves of container 12, attachable one to the other. In FIG. 1, for example, container 12 is constructed of two members: an open-top cylindrical bottle 12′ and a screwable cap 12″ which fits on top of bottle 12′. Members 12′ and 12″ are assembled to form a sealed cylindrical container 12. This arrangement facilitates access to the inside of container 12, allowing placement, securing, adjustment or replacement of hard tissue 20, material 16 and, if included, of means 18 for fixing within container 12.

Preferably, phantom 10 further includes a means 18 for fixing a position of hard tissue 20 within container 12. Preferably, means 18 for fixing a position employs a foam. Means 18 are any means capable of ensuring that hard tissue 20 remains stationary inside container 12. In such cases where material 16 is a liquid that is less dense than the hard tissue, means 18 will also preferably prevent flotation of hard tissue 20. In FIG. 1, for example, means 18 consists of two slices of semi-rigid, porous foam, each slice being placed in an area of contact between hard tissue 20 and an internal wall of container 12. This configuration increases friction and pressure between hard tissue 20 and an internal surface of container 12 ensuring that hard tissue 20 is properly secured.

The present invention is further embodied by a method of producing an ultrasound phantom 10 simulating hard and soft tissue of a first vertebrate organism. The method includes the steps of removing a hard tissue 20 from a second vertebrate organism and covering at least a portion of hard tissue 20 from the second vertebrate organism with a material 16 having ultrasonic properties similar to those of a soft tissue. Preferably the method includes the additional step of containing within a container 12, hard tissue 20 and material 16 covering at least a portion of the hard tissue. More preferably, the method includes the additional step of fixing a position of hard tissue 20 derived from a second vertebrate organism within container 12. This is accomplished using means 18 for fixing as described hereinabove.

The present invention is further embodied by a method of testing an ultrasonic diagnostic system. The method includes the steps of transmitting a train of ultrasonic energy towards a phantom as described hereinabove, receiving a portion of the train of ultrasonic energy and analyzing the received portion of the train of ultrasonic energy. Preferably the method includes the additional step of containing phantom 10 within a container 12. More preferably, the method includes the additional step of fixing a position of hard tissue within container 12.

Ultrasound phantom 10 may be used according to various methods of operation and in connection with various types of ultrasonic equipment, depending on the needs of the user. Referring to FIG. 2, an example of a method of using ultrasound phantom 10 in connection with an ultrasonic diagnostic system 30, is described. Ultrasonic diagnostic system 30 may be, for example, an ultrasonic bone evaluation system. Ultrasonic diagnostic system 30 includes a first ultrasonic probe 32 and a second ultrasonic probe 34, both capable of emitting and receiving ultrasonic energy.

In a first mode of operation, i.e. a through-transmission mode, the probes 32 and 34 are coupled to an external surface of container 12 of phantom 10, for example, in such a manner that the probes face each other. An ultrasound coupling material 36 is applied between each probe and the surface of container 12 of phantom 10, in order to facilitate transmission of ultrasound. Upon a command issued by ultrasonic diagnostic system 30, first probe 32 transmits a train of ultrasonic energy toward hard tissue 20 of phantom 10. The ultrasonic energy then partially penetrates the surface of container 12 and travels through material 16 and hard tissue 20, eventually being received by second probe 34. Ultrasonic diagnostic system 30 can then analyze the received ultrasonic energy, and evaluate certain characteristics of hard tissue 20 based on this analysis. This analysis may require, for example, converting the received ultrasonic signal to an electrical signal; digitally sampling the electrical signal; and processing the digital data according to a desired data processing algorithm.

In a second mode of operation, i.e. a pulse-echo mode, only first probe 32 is coupled to the surface of container 12 of phantom 10. Probe 32 transmits a train of ultrasonic energy toward hard tissue 20 of phantom 10. The ultrasonic energy then partially penetrates the surface of container 12 and travels through material 16 and to hard tissue 20. Some of the ultrasonic energy is reflected back from hard tissue 20 and received by first probe 32. Ultrasonic diagnostic system 30 can then analyze the received ultrasonic energy, and evaluate certain characteristics of hard tissue 20 based on this analysis, as explained hereinabove.

It is a particular feature of the ultrasound phantom 10 of the present invention that it comprises hard tissue 20 and is, therefore, more accurate than prior art ultrasound phantoms which rely on artificial hard tissue mimicking materials. Furthermore, an ultrasound phantom of the present invention can be easily constructed using only economical and readily available materials, with no need for special manufacturing facilities.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed:

1. An ultrasound phantom simulating hard and soft tissue of a first vertebrate organism, the phantom comprising:
(i) a hard tissue derived from a second vertebrate organism; and
(ii) a material covering at least a portion of said hard tissue derived from a second vertebrate organism, said material having ultrasonic properties similar to those of soft tissue.

2. The ultrasound phantom of claim 1, wherein said hard tissue derived from a second vertebrate organism exhibits ultrasonic properties similar to said hard tissue in situ in said second vertebrate organism.

3. The ultrasound phantom of claim 1, wherein said hard tissue derived from a second vertebrate organism exhibits ultrasonic properties similar to said hard tissue of said first vertebrate organism in situ.

4. The ultrasound phantom of claim 1, wherein said first vertebrate organism and said second vertebrate organism are each independently selected from the group consisting of a rodent, a canine species, a feline species, an ovine species, a bovine species, a caprine species, a porcine species, an equine species, an avian species, an ichthyic species, a primate species and a human being.

5. The ultrasound phantom of claim 1, wherein said hard tissue derived from a second vertebrate organism includes at least one item selected from the group consisting of bone tissue, cartilage tissue and teeth.

6. The ultrasound phantom of claim 1, wherein said hard tissue derived from a second vertebrate organism exhibits a clinical pathology.

7. The ultrasound phantom of claim 6, wherein said clinical pathology is selected from the group consisting of a fracture, abnormal growth, metabolic disease, osteoporosis, osteomyelitis, osteoarthritis, osteonecrosis and presence of at least one tumor.

8. The ultrasound phantom of claim 1, wherein said hard tissue derived from a second vertebrate organism further includes at least one medical accessory.

9. The ultrasound phantom of claim 8, wherein said medical accessory is selected from the group consisting of a nail, a screw, a pin, a staple and an anchor.

10. The ultrasound phantom of claim 1, wherein said material covering at least a portion of said hard tissue derived from a second vertebrate organism includes at least one item selected from the group consisting of a liquid, a gel, a polymeric and a granular material.

11. The ultrasound phantom of claim 1, further comprising:
(iii) a container, said container capable of containing said hard tissue derived from a second vertebrate organism and said material covering at least a portion of said hard tissue.

12. The ultrasound phantom of claim 11, wherein said container is selected from the group consisting of a rigid container and a flexible container.

13. The ultrasound phantom of claim 11, wherein said container comprises at least two pieces, such that said container may be opened and closed.

14. The ultrasound phantom of claim 11, further comprising:
(iv) a means for fixing a position of said hard tissue derived from a second vertebrate organism within said container.

15. The ultrasound phantom of claim 14, wherein said means for fixing a position employs a foam.

16. A method of producing an ultrasound phantom simulating hard and soft tissue of a first vertebrate organism, the method comprising the steps of:
(i) removing a hard tissue from a second vertebrate organism; and
(ii) covering at least a portion of said hard tissue from said second vertebrate organism with a material having ultrasonic properties similar to those of a soft tissue.

17. The method of claim 16, comprising the additional step of:
(iii) containing within a container, said hard tissue derived from a second vertebrate organism and said material covering at least a portion of said hard tissue.

18. The method of claim 17, comprising the additional step of:
(iv) fixing a position of said hard tissue derived from a second vertebrate organism within said container.

19. A method of testing an ultrasonic diagnostic system, the method comprising the step of:
(i) transmitting a train of ultrasonic energy towards a phantom, said phantom comprising:
( [symbol] ) a hard tissue derived from a second vertebrate organism; and
( [symbol] ) a material covering at least a portion of said hard tissue derived from a second vertebrate organism, said material having ultrasonic properties similar to those of a soft tissue;
(ii) receiving a portion of said train of ultrasonic energy; and
(iii) analyzing said portion of said train of ultrasonic energy.

20. The method of claim 19, comprising the additional step of:
(iv) containing within a container, said phantom.

21. The method of claim 20, comprising the additional step of:
(v) fixing a position of said hard tissue derived from a second vertebrate organism within said container.
